(19) United States
(12) Patent Application Publication
(10) Pub. No.: US 2022/0035387 A1
(43) Pub. Date: Feb. 3, 2022

(54) TEMPERATURE ADJUSTING DEVICE FOR A THERMOSTATIC MIXING VALVE AND RELATED THERMOSTATIC MIXING VALVE

(71) Applicant: BÖME S.R.L., Cavallirio (IT)

(72) Inventor: Carlo MEDINA, Cavallirio (IT)

(21) Appl. No.: 17/386,605

(22) Filed: Jul. 28, 2021

(30) Foreign Application Priority Data
Jul. 29, 2020 (IT) 102020000018361

(51) Int. Cl. G05D 23/13; F16K 31/00

(52) U.S. Cl. CPC G05D 23/1346; F16K 31/002

(57) ABSTRACT

Temperature adjusting device couplable with a valve body of a thermostatic mixing valve, including:
a hollow housing provided with a wall having at least one portion shaped for coupling firmly with an opening end provided on the valve body;
an adjusting element received inside the housing and movable along an operating direction with respect to the housing between a first calibrating position and a second calibrating position to adjust, in use, a mixing temperature of a flow of water exiting the valve body;
on the wall at least one opening being obtained that is shaped for receiving a locking element, the adjusting element including an abutting portion shaped for abutting on the locking element so as to arrest a movement of the adjusting element and limit a stroke thereof between the first and second calibrating position.

### TECHNICAL FIELD

The invention relates to a temperature adjusting device couplable to a thermostatic mixing valve.

In particular, the invention relates to a temperature adjusting device that is shaped to adjust a temperature of a mixed flow, such as water, exiting the valve.

### BACKGROUND OF THE INVENTION

It is known using thermostatic mixing valves upstream of hydraulic systems for industrial or domestic use, where water is supplied to one or more users at a desired temperature. There are also known standards which set a maximum, or minimum temperature, of the temperature of the flow of water exiting the valve. Such exit temperature substantially corresponds to the maximum, or minimum temperature of the water circulating in such hydraulic systems, and which arrives at sanitary devices, such as sinks, toilets and bath tubes, and the like. It is for instance known a US standard, called “ASSE 1070”, or an Australian standard, which establish that the temperature of the mixed water exiting the valve must not exceed a temperature of nearly 120.0° F., corresponding to about 49° C., in order to limit the risk of burns to the detriment of the user during use.

It is known a thermostatic valve wherein a temperature adjusting device is suitable for being screwed to a valve body. Screwing occurs by interposing a screwing element between the adjusting device and the valve body. The adjusting device includes a thermostatic handle; an angular rotation of the handle with respect to the valve body enables to adjust an exit temperature of the flow of water from the valve. The handle is shaped such to enable assembling an auxiliary calibrating, limitation and locking device. Such an auxiliary device is arranged to calibrate, limit and lock the position of the handle on the valve such to adjust a temperature value of the exiting fluid, such as maximum exit temperature value. The auxiliary device includes a calibrating ring, shaped to enable a user to rotate the handle between two rotation limit angles, in both rotation directions, to set an exit temperature of the fluid from the valve. The device further includes a limitation ring including two arrest portions in contact with the outer surface of the handle to limit a further handle rotation, once the exit temperature of the fluid has been set. This enables to keep the exit temperature of the flow from the valve at the set temperature. The device includes an arrest element shaped to be coupled to the calibrating ring and the limitation ring such to prevent a movement of the limitation ring with respect to the calibrating ring and such to prevent removing such limitation ring without giving evidence of an attempted or actual tampering of the valve.

A temperature adjusting device as the one just disclosed has some drawbacks. The structure of the adjusting device is in fact rather complex, as the handle must be shaped to enable assembling three distinct elements, each of them suitable for performing a specific function, i.e., a calibrating function, a temperature-limiting function and evidence of occurred tampering function.

This adds to the fact that manufacturing, assembling and maintaining both the handle and the auxiliary device is expensive. Furthermore, it is energy and time-consuming for an operator to proceed in carrying out such steps.

### SUMMARY OF THE INVENTION

An object of the invention is to improve the prior art temperature adjusting devices that can be coupled to mixing valves.

Another object of the invention is to provide a temperature adjusting device that is structurally simplified and shaped to be easily coupled with a locking element such to limit an exit temperature of a flow outgoing from the valve below a pre-set maximum value.

Still another object of the invention is to provide a temperature adjusting device shaped to enable a user to detect an attempted or occurred tampering of the locking element.

An additional object of the invention is to provide a mixing valve provided with a temperature adjusting device and a locking element having a simplified structure and shaped to be mutually couplable in order to adjust the temperature of the mixing water exiting the thermostatic valve, and, at the same time, give evidence of an attempted or actual removal of such a locking element.

Such objects and still others are reached by a temperature adjusting device as described in one or more of the herein reported claims.

According to the invention, it is provided a temperature adjusting device including a housing that can be firmly coupled to a valve body, and on which at least one opening is obtained. Owing to the shape of the at least one opening it is possible to receive a locking element inside the housing.

According to the invention, it is provided an adjusting device including an adjusting element slidably received inside the housing to adjust a mixing temperature of a flow of water exiting the valve body. The adjusting element includes an abutting portion shaped to abut on the part of the locking element penetrated into the housing. Owing to the abutment between the locking element and the abutting portion, it is possible to arrest a movement of the adjusting element and limit a stroke thereof, consequently limiting an exit temperature of the flow of water outgoing from the valve body.

According to the invention it is provided a locking element provided with shaped protrusions to abut, in use, on an inner surface of the housing adjacent the at least one opening.

Owing to the peculiar geometry of the at least one opening and locking element, an easy extraction of the locking element from the at least one opening is prevented, unless the locking element gets broken.

### BRIEF DESCRIPTION OF THE DRAWINGS

The invention will be better understood and implemented by referring to the accompanying drawings that illustrate an embodiment thereof by way of non-limiting example, wherein:

FIG. 1 is a perspective view of a mixing valve provided with a temperature adjusting unit according to the invention, wherein a locking element is decoupled from the temperature adjusting unit;

FIG. 2 is a view similar to that of FIG. 1 wherein the locking element is coupled to the temperature adjusting unit;

FIG. 3 is a perspective view of the locking element of FIG. 1;

FIG. 3A is a plan view of the locking element of FIG. 3;

FIG. 4 is a section front view of FIG. 1;

FIG. 4A is an enlarged detail of FIG. 4;

FIG. 5 is a section front view of the valve of FIG. 1 wherein an adjusting element of the temperature adjusting device adopts a first calibrating position with respect to a housing of such temperature adjusting device;

FIG. 5A is a section front view of the valve of FIG. 1 wherein an abutting portion of the adjusting element abuts on the locking element;

FIG. 6 is a section front view of the valve of FIG. 1 without the locking element and wherein the adjusting element of the temperature adjusting device adopts a second calibrating position with respect to the housing.

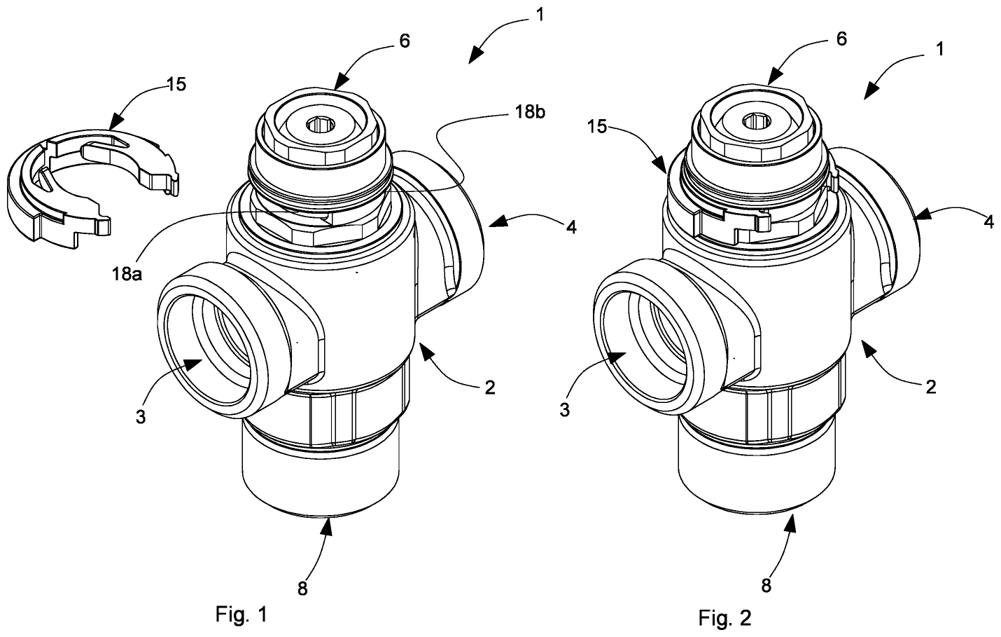

### DETAILED DESCRIPTION

With reference to the enclosed Figures, it is shown a thermostatic mixing valve 1 suitable for being assembled in a building heating circuit, in particular in sanitary systems, and having the function to maintain the temperature of the mixed water constant, at a desired value. The thermostatic mixing valve may be assembled upstream of a system for supplying a fluid to one or more users.

As will be clear in more detail from the following description, the thermostatic mixing valve 1 is configured to keep the temperature of the mixed water at a desired value based on a calibration or setting operation carried out on the components of the valve. Furthermore, the thermostatic mixing valve 1, or thermostatic mixing valve unit, enables to self-regulate the temperature as the water supply conditions, i.e., the temperatures of the entering water flows vary.

The thermostatic mixing valve 1 includes a valve body 2 provided with an inner cavity 20.

The valve body 2 includes a first inlet 3 for a first flow F1 of water into the cavity 20, in particular a flow of hot water, a second inlet 4 for a second flow F2 of water into the cavity 20, in particular cold water, and an outlet 8 for a third flow F3 of mixed water exiting from the cavity 20 and the valve body 2.

The first inlet 3 and the second inlet 4 are provided on two opposite walls of the valve body 2. The first inlet 3 and the second inlet 4 are obtained on the walls of the valve body 2 such that the first flow F1 and the second flow F2 enter the cavity 20 according to two flow directions that are substantially parallel and opposite to each other. The outlet 8 is provided on another valve body wall, distinct from the two previously described walls, and it is positioned with respect to the first 3 and the second inlet 4 such that the third flow F3 exits the cavity 20 in a transversal exit direction, in particular orthogonal, with respect to the entry direction of the first F1 and/or second F2 flow.

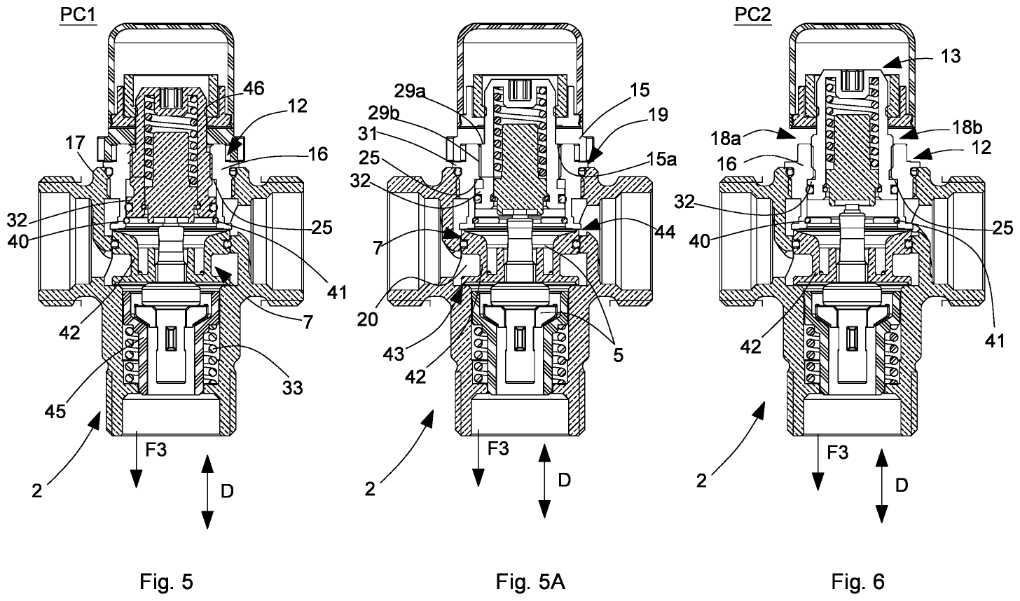

With reference to FIG. 5A, an opening end 19 is obtained on the valve body 2 in a position opposite to the exit 8.

The valve 1 includes a mixing device 7 removably housed in the cavity 20. The opening end 19 is sized to allow inserting a mixing device 7 into the cavity 20.

The mixing device 7 is further shaped to be placed in fluid connection with the first inlet 3, with the second inlet 4 and with the outlet 8. The mixing device 7 is also shaped to define a mixing chamber 5 in the cavity 20 for the first flow F1 and second F2 flow, inside which the first flow F1 and the second F2 flow can be mixed to obtain the third flow F3 of mixed water.

The mixing device 7 is internally provided with a thermostatic actuator element 10 movable along an operating direction D. The thermostatic actuator element 10 is immersed in the mixing chamber 5, i.e., it is in contact with the first F1 and/or second F2, and/or third F3 flow and is able to contract or dilate based on the temperature of such first F1 and/or second F2 and/or third F3 flow. The thermostatic actuator element 10 includes in particular a wax thermosensitive sensor. In the version shown in the enclosed Figures, the operating direction D is transversal, in particular orthogonal, to the entry direction of the first flow F1.

A temperature adjusting device 6 that is configured to adjust, in use, a temperature of the third flow F3 of mixed water, as will be hereinafter explained, may be connected to the valve 1.

The temperature adjusting device 6 includes a housing 12. The housing 12 is hollow and is delimited by a wall 16 having at least one portion 17 shaped for coupling firmly with the opening end 19 provided on the valve body 2. In particular the portion 17 is couplable by screwing with an inner wall of such opening end 19.

The housing 12 has a shape of a hollow cylinder. The hollow cylinder is open at both ends.

The housing 12 further includes an annular flange 31 shaped to abut on a surface of the valve body 2 adjacent to the opening end 19 so as to define an arrest for screwing the housing 12 on the opening end 19.

The temperature adjusting device 6 includes an adjusting element 13 received inside the housing 12 and movable along an operating direction D with respect to the housing 12 between a first calibrating position PC1 and a second calibrating position PC2 to adjust, in use, a mixing temperature of a flow, in particular the third flow F3 of water exiting the valve body 2, as hereinafter explained.

The adjusting element 13 is defined by a cylindrical body; such cylindrical body is provided with a wall 29 including a first wall portion 30a on which an annular ridge is obtained 32.

The annular ridge 32 is shaped for being sealingly coupled with the wall 16 of the housing 12; the annular ridge 32 is further configured to abut on a first abutting shoulder 25 obtained on the wall 16 of the housing 12.

The wall 29 further includes a second wall portion 30b wherein an abutting portion 14, which reference will be made in the hereinafter disclosure, is obtained.

The wall 29 further includes a third portion 30c having a thickness that is less than the second portion 30b; the second portion 30b is provided between the first 30a and the third portion 30c.

The adjusting element 13 further includes an additional wall 28 transversally oriented, in particular orthogonally, to the wall 29 to close an end thereof. In other words, the adjusting element is a cap-shaped cylindrical body. The third portion 30c is provided between the second portion 30b and the further wall 28.

The adjusting element 13 is coupled by screwing with the housing 12. A rotation of the adjusting element 13 around a rotation axis R thereof permits a movement of the adjusting element 13 along the operating direction D between the first PC1 and second PC2 calibrating position, respectively shown in FIG. 5 and in FIG. 6. Moving between the first PC1 and second PC2 calibrating position, the adjusting element 13 adopts a predetermined position with respect to the housing 12. In the version shown in the enclosed figures, the longitudinal axis R is parallel to the operating direction D.

A positioning member 11 is slidably housed inside the adjusting element 13. The positioning member 11 includes a plate-shaped element, or a piston.

While screwing, a rotation of the adjusting element 13 around a longitudinal axis R thereof enables the positioning member 11 to move along the operating direction D with the adjusting element 13 so that the positioning member also adopts a predetermined position with respect to the housing 12.

As may be assumed from what described and from the enclosed figures, the housing 12 is provided with threads obtained on two cylindrical surfaces defining the cylindrical wall 16 of the housing 12 and opposite to each other. In particular a first thread is obtained on an outer cylindrical surface to enable screwing the housing 12 on the wall of the opening end 19, and another thread is obtained on an inner cylindrical surface to enable the adjusting element 13 to be screwed inside the housing 12, as will be hereinafter explained. The screwing of the adjusting element 13 in the housing 12 is totally independent from the screwing of the housing 12 in the opening end 19.

As already mentioned above, the adjusting element 13 is movable between the first PCI and the second PC2 calibrating position. In the first calibrating position PC1, shown in FIG. 5, the annular ridge 32 of the adjusting element 13 is placed below, and at a maximum distance from, the abutting shoulder 25 of the wall 16, the distance being measured in a direction parallel to the operating direction.

On an end portion of the wall 16 an annular groove 40 is obtained and sized to house a stop ring 41. The annular groove 40 is radially hollow with respect to the wall 16. The stop ring 41 is shaped so as to radially protrude from the annular groove 40 inside the housing 12 and to abut on the annular ridge 32 so as to limit a movement thereof along the operating direction D and prevent the adjusting element 13 from exiting the housing 12 during the screwing operation. The stop element 41 is made of metal material. In the first calibrating position PCI the annular ridge 32 is in contact with the stop ring 41.

In the second calibrating position PC2, shown in FIG. 6, the annular ridge 32 of the adjusting element 13 is in contact with the abutting shoulder 25 of the wall 16 and a rotation of the adjusting element 13 with respect to the housing 12 is prevented. The first calibrating position PCI may correspond to a minimum exit temperature of the third flow F3 outgoing from the outlet 8 of the valve body 2, while the second calibrating position PC2 may correspond to a maximum exit temperature of the third flow F3 outgoing from the outlet 8 of the valve body 2, as will be hereinafter explained.

Inside the adjusting element 13, in particular on an inner wall 39 of the adjusting element 13, an annular housing is obtained 34 to receive an abutting ring 35. The abutting ring 35 is made of an elastic rigid, or semi-rigid material, for example a metal alloy. The abutting ring 35 is partially protruding in a radial direction inside the adjusting element 13 and is sized to abut on the positioning member 11 so as to limit a movement thereof along the operating direction D and prevent such positioning member 11 from exiting the adjusting element 13.

Inside the adjusting element 13 it is provided a spring member 46 that is operationally connected to the positioning member 11 and that is sized to apply an elastic force on the positioning member 11 so as to maintain the positioning member abutting on said abutting ring 35. The spring member 46 includes a compression spring fixed with a first end to an upper base wall of the adjusting element 13, and with another end to the positioning member 11.

The temperature adjusting device 6 further includes a safety ring nut 36 coupled by screwing with the cylindrical body 13, in particular coupled by screwing with a portion of the wall protruding out of the housing 12. The safety ring nut 36 is shaped to be screwed on such wall portion after the cylindrical body 13 has been screwed/rotated into the housing 12, until abutting a second abutting shoulder 38 obtained on the housing 12 so as to lock in place the cylindrical body 13 with respect to the housing 12 and prevent possible undesired movements, or unscrewing.

In use, the temperature adjusting device 6 is shaped for coupling with the mixing device 7 along a coupling surface. The coupling surface may be a plane surface, i.e., the mixing device 7 and the temperature adjusting device 6 include, at the interface, two plane surfaces which couple along a plane surface. Alternatively, the mixing device 7 and the temperature adjusting device 6 may include at the interface concave/convex surfaces, with an irregular trend; therefore, the coupling surface will be a complex, non-plane, wavy surface.

In use, the temperature adjusting device 6 is shaped so as to close the opening end 19 of the valve body 2.

In use, the positioning member 11, having adopted the set position with respect to the housing 12 as described above, is in contact with the thermostatic actuator element 10. In particular the positioning member 11 is in contact with an end portion 14 of the thermostatic element 10. The positioning member 11 is thus configured to impose to the thermostatic actuator element 10 an operating position along the operating direction D; such operating position corresponds to a desired mixing temperature of the first F1 and second F2 flow, and therefore nearly corresponds to the exit temperature of the third flow F3 from the valve body.

The mixing device 7, in fact, includes a plug member 42 which delimits a space in the cavity 20 wherein the two flows F1 and F2 can mix, defining the aforesaid mixing chamber 5.

The plug member 42 includes a hollow tubular body. The plug member 42 is connected to the thermostatic actuator element 10 and adopts a position in the cavity 20 based on the operating position adopted by the thermostatic actuator element 10.

The plug member 42 is also drivable along the operating direction D through the effect of a contracting/dilating movement of the thermostatic actuator element 10.

The plug member 42 is shaped to cooperate with the inner walls of the cavity 20 along the operating direction D to define a first variable area passage 43 and a second variable area passage 44 for the access into the mixing chamber of the first flow F1 and the second flow F2 respectively.

Owing to the movement of the thermostatic actuator element 10 and of the plug member 42, it is possible to control the first flow F1 and the second flow F2 entering the mixing chamber 5 so as to maintain the third flow F3 at a desired mixing temperature.

Referring to FIG. 5, it is shown the valve according to the invention wherein the adjusting element 13 has adopted a first calibrating position PC1 with respect to the housing 12 in which the annular ridge 32 is in contact with the stop ring 41. Consequently, the positioning member 11, based on the rotation of the adjusting element 13, has been moved along the operating direction D and has adopted a first position with respect to the housing 12. In such first position, the positioning member 11 imposes to the end portion 14, and thereby to the thermostatic actuator element 10 a first operating position. Such calibrating position corresponds to a position adopted by the plug member 42 and to a first passage 43 (shown in FIG. 5A) of the first flow F1 of hot water and a second passage 44 (shown in FIG. 5A) of the second flow F2 of cold water into the mixing chamber 5, and to a corresponding first mixing temperature at which the third flow F3 exits from the mixing chamber and the valve body 2. In the first calibrating position PC1, the first passage 43 has an area smaller than the second passage 44. In particular the value of the area of the first passage 43 may be minimum, therefore such first calibrating position will correspond to a minimum mixing temperature at which the third flow F3 exits from the mixing chamber 5 and from the valve body 2.

Similarly, referring to FIG. 6, it is shown the valve according to the invention wherein the adjusting element 13 has adopted a second calibrating position PC2 with respect to the housing 12 in which the annular ridge 32 is in contact with the abutting shoulder 25. The positioning member 11 has been moved along the operating direction D and has adopted a second position with respect to the housing 12. In such second position, the positioning member 11 imposes to the end portion 14, and consequently, to the thermostatic actuator element 10 a second operating position. Such second calibrating position corresponds to a second position adopted by the plug member 42 in the cavity 20, and to a consequent variation of the area of the first passage 43 and of the second passage 44. In particular, the area of the first passage 43 will increase up to a maximum value, while the area of the second passage will decrease to a minimum value. This second calibrating position PC2 will correspond to a maximum mixing temperature at which the third flow F3 exits from the mixing chamber 5 and from the valve body 2.

In both the calibrations configurations just shown, a variation in the temperature of the hot and/or cold flow of water entering the mixing chamber causes a dilation and/or contraction of the thermostatic actuator element 10, and an additional consequent movement of the plug member 42 along the operating direction D so as to vary the passage areas 43 and 44. This enables to balance/control the flows entering the mixing chamber 5 and maintain the third flow F3 at the desired mixing temperature.

The mixing device 7 is further provided with a guide tubular element 45, shown in FIG. 4, arranged to guide the third flow F3 of mixed water from the mixing chamber 5 towards the outlet 8 of the valve body 2. The guide tubular element 45 is also connected to the thermostatic actuator element 10 by at least one protrusion, not shown, radially protruding from an inner surface of a wall of the guide tubular element 45 facing the thermostatic actuator element 10. Therefore, the guide tubular element 45 is also sliding along the operating direction D and is susceptible to movements deriving from an imposition of the position imposed to the thermostatic actuator element 10 by the positioning member 11, and by a contraction/dilation of the same thermostatic actuator element 10 while the flows circulate in the mixing chamber 10.

The guide tubular element 45 is in fluid connection with the mixing chamber 5.

The guide tubular element 45 is connected to an additional spring member 33 sized to apply on the guide tubular element 43 an elastic force such to keep in contact the at least one protrusion with the shoulder of the thermostatic actuator element 10. The additional spring member 33 includes a compression spring.

Often, in use, in particular in the second calibration position PC2, the maximum temperature of the flow F3 exiting the valve body 2, is greater than the maximum temperature set by the standards, provided for reducing risks of burns detrimental for the user.

The temperature adjusting device 6 is shaped to limit, in use, the maximum exit temperature of the flow F3 from the valve body 2, as hereinafter explained.

On the wall 16 of the housing at least one opening 18a is obtained that is shaped to receive a locking element 15 which will be referred to hereinafter.

The at least one opening 18a passes through a thickness of the wall 16.

The at least one opening 18a is also shaped such to prevent an extraction of the locking element 15 unless it gets broken with consequent evidence of attempted or actual tampering. The at least one opening 18a has an annular sector shape. In other words, the at least one opening 18a is shaped to extend on the wall 16 for a pre-established angular tract. The angular tract may be between 5° and 160°.

On the wall 16, at least one further opening 18b is obtained cooperating with the at least one opening 18a to receive the locking element 15. The opening 18a and the further opening 18b are obtained on the wall 16 of the housing 12 at diametrically opposite positions.

The further opening 18b is substantially the same as the opening 18a. In other words, the further opening 18b passes through the thickness of the wall 16, is shaped so as to prevent the locking element 15 being extracted, and has also an annular sector shape.

The mentioned positioning of the two openings increases the retention of the locking element 15 on the temperature adjusting device 6. This positioning forces anyone who intends to extract the locking element 15 from the opening 18a and from the further opening 18b, to exert such a force as to break the locking element 15.

The locking element 15, which the valve 1 is provided with, is in turn shaped to be inserted, in use, into the at least one opening 18a and into the at least one further opening 18b so as to emerge inside the housing 12. In other words, the locking element 15 is shaped to penetrate into the wall 16 through the openings 18a and 18b, and protrude at least partially inside the housing 12.

The adjusting element 13 includes an abutting portion 14 shaped for abutting on the locking element 15 so as to arrest a movement of said adjusting element 13 and limit a stroke thereof between the first PC1 and second PC2 calibrating position.

The abutting portion 14 is an annular portion. The abutting portion 14 includes at least one first surface 29a shaped for abutting on a face 15a of the locking element.

The abutting portion 14 further includes a second surface 29b shaped for coupling by screwing with a respective surface 37 of the wall 16 of the housing 12.

Referring to FIG. 5A, it is shown the valve according to the invention, wherein a rotation of the adjusting element 13 around the rotation axis R thereof caused a movement along the operating direction D with respect to the housing 12 from the first calibrating position PC1 towards the second calibrating position PC2. The movement of the adjusting element 13 was stopped due to the contact between the abutting portion 14 and the locking element 15. The adjusting element 13 adopts a calibrating position with respect to the housing 12, that is intermediate between the first PC1 and the second PC2 calibrating position. The contact between the first surface 29a of the abutting portion 14 and the face 15a of the locking element 15 also prevents the operator from keeping on rotating the adjusting element 13 so that it reaches the second calibrating position PC2. The positioning member 11 thereby imposes to the thermostatic actuator element 10 a further operating position corresponding to a mixing temperature lower than the maximum temperature at which the third flow F3 exits from the mixing chamber 5 and the valve body 2, and complying with the rules set by the standards.

The opening 18a and the further opening 18b are substantially obtained at the second portion 30b of the wall 29 of the adjusting element 13.

Basically, in the wall portion 16 where the openings 18a and 18b are obtained, the contact between the abutting portion 14 and the locking element 15 takes place.

The openings 18a and 18b are obtained on the wall 16 such that a height, at which the contact between the abutting portion 14 and the locking element 15 takes place, and the resulting locking of the adjusting element 13 with respect to the housing 12, substantially corresponds to the maximum mixing temperature of the flow exiting from the valve set by the standard. The height at which the contact between the abutting portion 14 and the locking element 15 takes place is measured in a direction that is substantially parallel to the operating direction D, from one of the housing ends 12.

The first surface 29a is a plane surface. Similarly, the face 15a is also a plane face; the first surface 29a and the face 15a can couple along a coupling plane surface. The first surface 29a is thus shaped to be easily moved away from said face 15a.

In fact, a rotation of the adjusting element 13 is permitted around the rotation axis R thereof such to cause a movement along the operating direction D with respect to the housing 12 from the abutting position between the abutting portion 14 and the locking element 15 towards the first calibrating position PC1.

This means that it will be possible to move the adjusting element 13 towards the first calibrating position PCI to lower the mixing temperature of the flow exiting from the valve body 2 to a lower value than the maximum value set by the standard.

In case the locking element 15 gets broken and is therefore extracted, it is possible to start again moving the adjusting element 13 between the first calibrating position PCI and the second calibrating position PC2.

The locking element 15 is made of deformable material; in particular, the locking element is made of plastic material, such as a polymer or technopolymer.

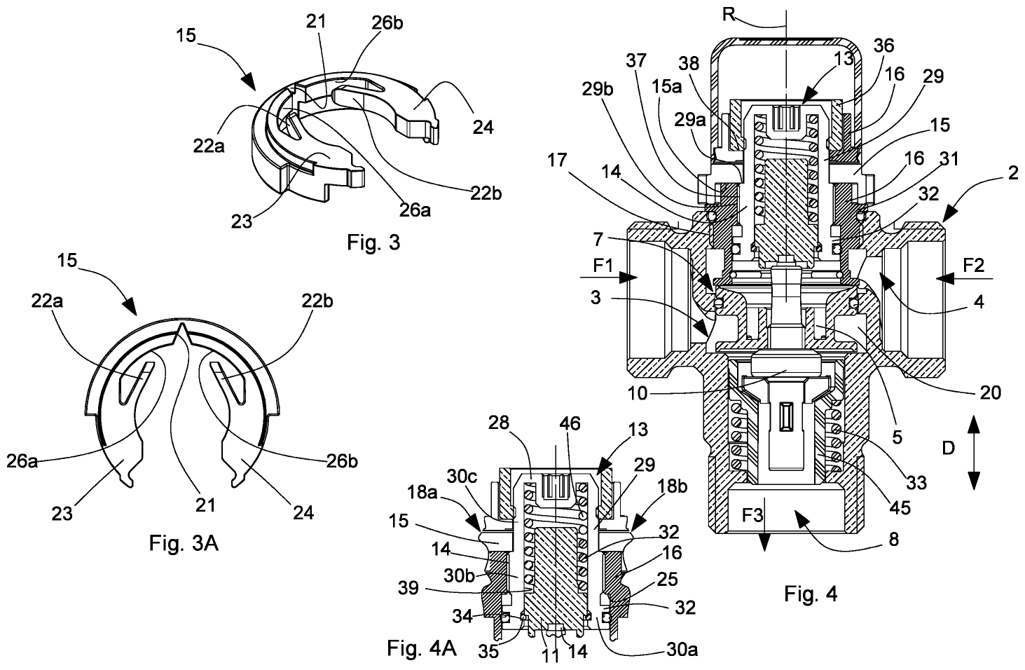

Referring to FIGS. 3 and 3A, the locking element 15 includes a body with annular sector shape. In other words, the locking element 15 includes an interrupted-ring-shaped body.

The body of the locking element 15 includes a first arm 23 and a second arm 24 that are elastically deformable away from each other, in use, to facilitate the insertion of the locking element into the opening 18a and the further opening 18b. In other words, the first arm 23 and the second arm 24 can be stretched apart to facilitate the insertion of the locking element 15.

The body of the locking element 15 further includes an abutting surface 26a, 26b shaped to abut, in use, on an outer surface of the wall 16 provided between the opening 18a and the further opening 18b.

The body further includes one first 22a and one second 22b anti-extraction protrusion that are shaped to abut, in use, on an inner surface of the wall 16 provided between said opening 18a and the further opening 18b so as to prevent an extraction of the locking element 15 unless the locking element 15 gets broken with consequent evidence of attempted or actual tampering.

The protrusion may be fins, as shown in the FIGS. 3 and 3A, extending for a given angular tract and shaped to abut on the inner surface of the wall 16 between the two openings 18a and 18b.

At least a notch 21 is provided on the abutting surface 26a, 26b which defines a preferential breaking zone for the locking element 15. The notch 21 may have an upside down V shape.

The locking element 15 is placed outside the temperature adjusting device 6 and can be easily seen. A breakage, or an attempt to break the locking device is therefore immediately visible from outside, giving evidence of an attempted or actual tampering of the temperature adjusting device.

Once the locking element 15 has been extracted from the temperature adjusting device 6, it is possible to set a value of the mixing temperature of the flow even at a value greater than the maximum permitted one with the presence of the locking element 15.

The removal of the locking element, besides indicating the actual or attempted tampering, also involves losing compliance with the reference standard. In other words, if a particular standard is referred to, such as the US Standard 1070, the presence of the locking element imposes that the exit temperature of the fluid outgoing from the mixing valve is no higher than a maximum value, such as 49° C. The locking element may be maliciously removed by a vandal and the temperature can be consequently increased. The locking element may also be removed voluntarily by an operator, for instance in case the valve has to be installed on a system wherein the limitation regarding the maximum exit temperature of the fluid may be set in compliance with another standard, which imposes for example a maximum temperature of 60° C.

Even though the breakage of the locking element means losing the certification of the reference standard, a mixing valve provided with such a temperature adjusting device and such locking element, is in any case potentially compliant with/suitable for the relative reference standard, as, if an additional locking element is subsequently assembled, it is capable of restoring an operating condition of the valve in compliance with such reference standard.

The temperature adjusting device 6 and the locking element 15 define a temperature adjusting and anti-tampering kit which can be associated to a thermostatic mixing valve 1 as the one just described.

To conclude, owing to the simple and cheap constructive shape of the adjusting device, it is possible, in use, to couple it to a mixing valve, and to provide inserting a locking element to limit the exit temperature of a flow outgoing from the valve, according to what set by the laws in force.

Furthermore, owing to the shape of the adjusting device and locking element it is possible to easily detect attempts to extract the locking element, and consequently tampering of the mixing valve.

1. Temperature adjusting device couplable with a valve body of a thermostatic mixing valve, including:
a hollow housing provided with a wall having at least one portion shaped for coupling firmly with an opening end provided on said valve body;
an adjusting element received inside said housing and movable along an operating direction with respect to said housing between a first calibrating position and a second calibrating position to adjust, in use, a mixing temperature of a flow of water exiting said valve body;
wherein on said wall at least one opening is obtained that is shaped for receiving a locking element, and that said adjusting element includes an abutting portion shaped for abutting on said locking element so as to arrest a movement of said adjusting element and limit a stroke thereof between said first and second calibrating position.

2. Temperature adjusting device according to claim 1, wherein said at least one opening passes through a thickness of said wall, said at least one opening being shaped so as to prevent an extraction of said locking element unless said locking element gets broken with consequent evidence of attempted or occurred tampering.

3. Temperature adjusting device according to claim 1, wherein said at least one opening has an annular sector shape.

4. Temperature adjusting device according to claim 1, wherein on said wall at least one further opening is obtained cooperating with said at least one opening to receive said locking element.

5. Temperature adjusting device according to claim 4, wherein said at least one further opening passes through said thickness of said wall, is shaped so as to prevent said locking element being extracted and has an annular sector shape.

6. Temperature adjusting device according to claim 1, wherein said abutting portion is an annular portion, said abutting portion including at least one first surface shaped for abutting on a face of said locking element and being easily moved away from said face.

7. Temperature adjusting device according to claim 1, wherein said abutting portion includes a second surface shaped for coupling by screwing with a respective surface of said wall of said housing, a rotation of said adjusting element around a rotation axis thereof permitting a movement of said adjusting element along said operating direction between said first and second calibrating position.

8. Temperature adjusting device according to claim 1, wherein said adjusting element is defined by a cylindrical body provided with a wall including a first wall portion, on said first wall portion being obtained an annular ridge shaped for being sealingly coupled with said wall of said housing, said wall further including a second wall portion in which said abutting portion is obtained, and a third portion having a thickness that is less than said second portion, said second portion being provided between said first and said third portion.

9. Temperature adjusting device according to claim 8, wherein on said wall at least one further opening is obtained cooperating with said at least one opening to receive said locking element, said adjusting element further includes a further wall transversely oriented to said wall of said adjusting element to close an end of said wall, said third portion being provided between said second portion and said further wall, said at least one opening and said at least one further opening being obtained at said second portion.

10. Thermostatic mixing valve including:
a valve body provided with an inner cavity, a first inlet for a first flow of water into said cavity, a second inlet for a second flow of water into said cavity, and with an outlet for an exit of a third flow of mixed water from said cavity;
a temperature adjusting device according to claim 1,
wherein it includes at least one locking element shaped for being inserted, in use, into said at least one opening and at least one further opening obtained on said wall so as to emerge inside said housing, said locking element being further shaped for defining an arrest position for said abutting portion so as to lock a movement of said adjusting element and limit a stroke thereof between said first and said second calibrating position.

11. Valve according to claim 10, wherein said at least one locking element is sized to limit said stroke in function of a first reference standard that sets a maximum exit temperature value of said flow of mixed water from said cavity, and in which removing by breaking said locking element enables said mixing valve to be used in conformity to a second reference standard indicating a different maximum exit temperature value of said flow of mixed water from said cavity.

12. Valve according to claim 10, wherein said locking element includes a body with annular sector shape.

13. Valve according to claim 12, wherein said body includes a first arm and a second arm that are elastically deformable away from one other, in use, to facilitate the insertion of said locking element into said at least one opening and said at least one further opening, said body further including an abutting surface shaped to abut on an outer surface of said wall provided between said at least one opening and said at least one further opening.

14. Valve according to claim 12, wherein said body further includes a first and a second anti-extraction protrusion shaped to abut, in use, on an inner surface of said wall provided between said at least one opening and said at least one further opening so as to prevent an extraction of said locking element unless said locking element gets broken with consequent evidence of attempted or actual tampering.

15. Valve according to claim 13, wherein on said abutting surface there is at least one notch, said notch defining a preferential breaking zone for said locking element.

16. Temperature adjusting and anti-tampering kit associable with a thermostatic mixing valve according to claim 10 including:
a temperature adjusting device according to claim 1;
at least one locking element couplable with said valve, wherein said locking element is sized to limit said stroke in function of a first reference standard that sets a maximum exit temperature value of said flow of mixed water from said cavity, and wherein the removal with breakage of said locking element enables said mixing valve to be used in conformity to a second reference standard indicating a different maximum exit temperature value of said flow of mixed water from said cavity.
